(19) United States
(12) Patent Application Publication
(10) Pub. No.: US 2012/0243722 A1
(43) Pub. Date: Sep. 27, 2012

(54) Speaker

(76) Inventor: To-Teng Huang, Taoyuan City (TW)

(21) Appl. No.: 13/067,323

(22) Filed: May 25, 2011

(30) Foreign Application Priority Data
Mar. 21, 2011 (TW) 100204988

(51) Int. Cl. H04R 1/10; H04R 1/00

(52) U.S. Cl. 381/371; 381/398; 381/380

(57) ABSTRACT

A speaker includes a ferrite yoke plate, an inner magnet, a first pole member, an outer magnet, a second pole member, a diaphragm, and a voice coil. Both the inner and the outer magnets are disposed on the ferrite yoke plate, and are spaced apart from each other. The first pole member is disposed on a top of the inner magnet, while the second pole member on a top of the outer magnet. Besides, a circumference of the first pole member and a circumference of the second pole member are spaced apart from each other and define a gap. The voice coil is connected with the diaphragm, and extends axially into the gap between the two pole members. Thereby, the magnetic line of force in the speaker can be more regularly concentrated, and the driving efficiency of the voice coil be promoted, making the present invention particularly suitable for micro-speakers.

### BACKGROUND OF THE INVENTION

1. Field of the Invention

The present invention relates to a speaker structure, and more particularly, to a twin-magnet speaker structure able to enhance driving efficiency.

2. Description of Related Art

Referring to FIG. 1A, a cross-sectional view illustrating a conventional speaker, the speaker primarily comprises a ferrite yoke 81, a magnet 82, a pole member 83, a voice coil 84, and a diaphragm 85. The ferrite yoke 81 has a bowl-like shape, and includes a horizontal portion 811 and a vertical portion 812 extending perpendicularly from circumference of the horizontal portion 811. The magnet 82 is cylindrical and the bottom thereof is disposed on a surface of the horizontal portion 811, and that top of the magnet 82 supports the pole member 83.

The vertical portion 812 of the ferrite yoke 81 extends axially and correspondingly to the pole member 83 and is spaced radially apart therefrom. The voice coil 84 has its one end connected with the diaphragm 85, while has it's another end extended in and between the vertical portion 812 and the pole member 83. Since the magnet 82 has its two ends of opposite polarities, the pole member 83, which contacts the top of the magnet 82, has an opposite polarity to the ferrite yoke 81 which contacts the bottom of the magnet 82, due to induction.

For the speaker, it is by supplying electric power to the voice coil 84 so as to make the same produce an induced magnetic field. The voice coil 84 is located in the magnetic field resulted from the pole member 83 and the ferrite yoke 81. The diaphragm 85 gives off sound owing to the attraction and repulsion caused by the induced magnetic field and the magnetic field.

Now referring to FIG. 2A, a cross-sectional view illustrating another conventional speaker, the speaker primarily comprises a ferrite yoke 91, a magnet 92, a pole member 93, a voice coil 94, and a diaphragm 95. Similarly, the ferrite yoke 91 also includes a horizontal portion 911 and a vertical portion 912 extending perpendicularly from the horizontal portion 911. The magnet 92 is annular and the bottom thereof is disposed on a surface of the horizontal portion 911, and that top of the magnet 92 supports the pole member 93.

The vertical portion 912 of the ferrite yoke 91 extends axially and correspondingly to the pole member 93 and is spaced radially apart therefrom. The voice coil 94 has its one end connected with the diaphragm 95, while has it's another end extended in and between the vertical portion 912 and the pole member 93. The principle that the speaker gives off sound is the same as that illustrated in FIG. 1A, and as such no redundancy on further description is necessary.

However, both the conventional speakers have a common defect, namely, distribution of the magnetic line of force between the pole member 83,93 and the ferrite yoke 81,91 becomes relatively scattered, due to the structural nature of the ferrite yoke 81,91. In other words, because the horizontal portion 811,911 and the vertical portion 812,912 constitute an L-shaped structure, part of the magnetic line of force from the pole member 83,93 is directed to the whole vertical portion 812,912 and a significant proportion of the magnetic line of force cannot pass through the voice coil 84,94, as shown in FIG. 1B, an enlargement of part of the conventional speaker as shown in FIG. 1A, and in FIG. 2B, an enlargement of part of the conventional speaker as shown in FIG. 2A. Due to a broader bandwidth distribution is required for various types of music, the problem of non-concentration for the magnetic line of force causes limitation on the ability of original sound reproduction.

### SUMMARY OF THE INVENTION

The present invention is to provide a speaker, comprising a ferrite yoke plate, an inner magnet, a first pole member, an outer magnet, a second pole member, a diaphragm, and a voice coil. Both the inner and the outer magnets are disposed on the ferrite yoke plate, and are spaced apart from each other.

According to the present invention, the first pole member is disposed on a top of the inner magnet, while the second pole member on a top of the outer magnet. Besides, a circumference of the first pole member and a circumference of the second pole member are spaced apart from each other, and define a gap. The voice coil is connected with the diaphragm, and extends axially into the gap between the two pole members.

Through the speaker structure, according to the present invention, the magnetic line of force in the speaker can be more regularly concentrated in a range, perpendicularly intersected with motion of the voice coil, at the gap between the two pole members, where most of the magnetic field energy is employed for driving. The present invention is particularly suitable for micro-speakers such as earphones. This is because the driving power is used effectively, so that the micro-dimensional diaphragm can produce amplitude for pushing a comparatively great amount of air so as to increase feeling of the weight of the bass, and to enhance fineness of the treble. Therefore, the range of dynamic musical appreciation can be promoted.

The speaker may further comprise a housing and an earmuff, wherein the housing and the earmuff define an accommodating space such that the ferrite yoke plate, the inner magnet, the first pole member, the outer magnet, the second pole member, the diaphragm, and the voice coil are received in the accommodating space.

Still further, the speaker may relate to an earphone or a headphone.

Other objects, advantages, and novel features of the present invention will become more apparent from the following detailed description when taken in conjunction with the accompanying drawings.

### BRIEF DESCRIPTION OF THE DRAWINGS

FIG. 1A is a cross-sectional view illustrating a conventional speaker;

FIG. 1B is an enlargement of part of the conventional speaker as shown in FIG. 1A;

FIG. 2A is a cross-sectional view illustrating another conventional speaker;

FIG. 2B is an enlargement of part of the conventional speaker as shown in FIG. 2A;

FIG. 3 is an exploded view illustrating an earphone embodying a speaker according to a first embodiment of the present invention;

FIG. 4 is an exploded view illustrating a speaker unit according to the first embodiment of the present invention;

FIG. 5 is a cross-sectional view illustrating the speaker unit according to the first embodiment of the present invention; and

FIG. 6 is a perspective view illustrating a headphone embodying a speaker according to a second embodiment of the present invention.

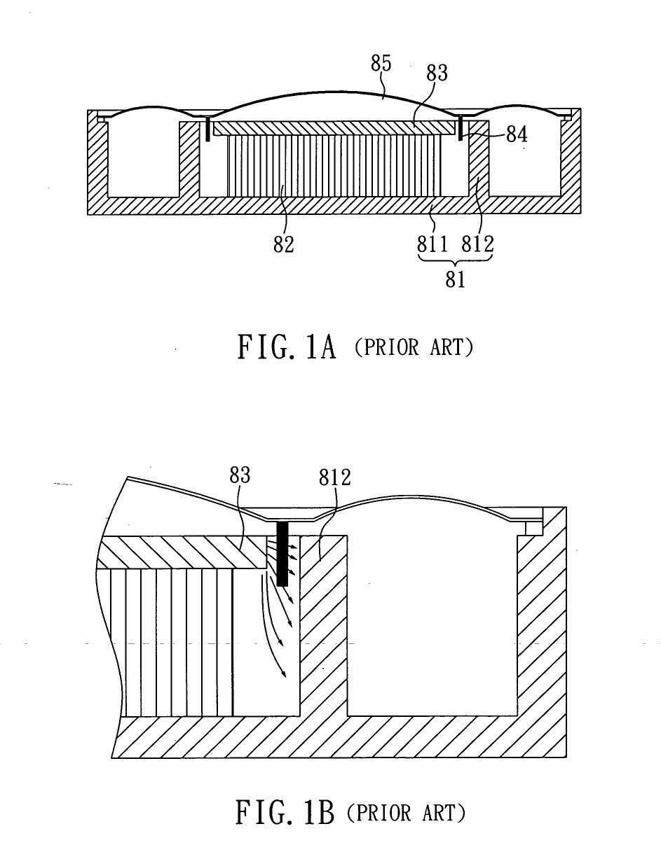

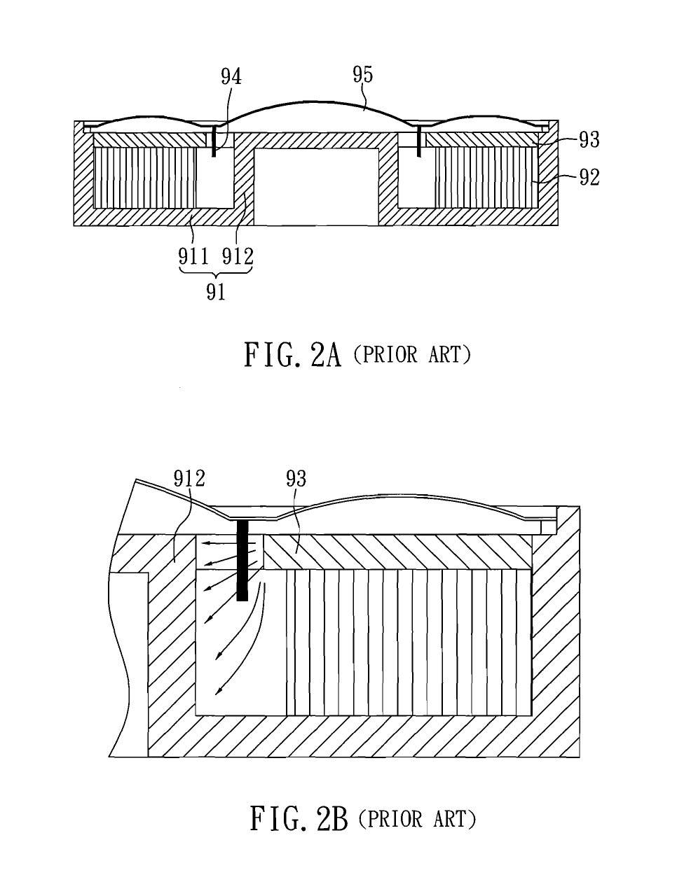

### DETAILED DESCRIPTION OF THE PREFERRED EMBODIMENTS

In order to solve the problem that operation of a speaker will result in waste on scattering magnetic line of force in the speaker, the present invention proposes an innovative speaker structure featured in having a concentration effect on magnetic line of force. To the effect, the present invention does not adopt the L-shaped ferrite yoke having a long vertical portion, as the conventional art, but instead adopts a ferrite yoke plate, together with an additional magnet-and-pole member assembly, for concentrating the magnetic line of force in the speaker.

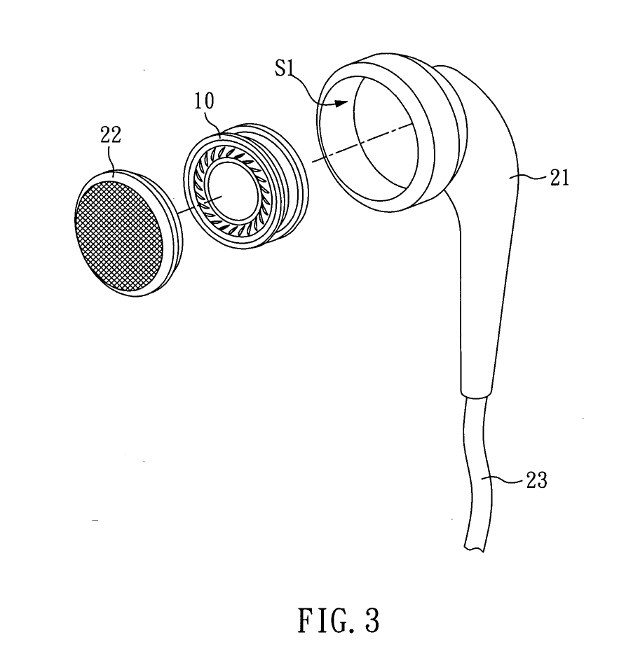

Referring to FIG. 3, an exploded view illustrating an earphone embodying a speaker according to a first embodiment of the present invention, the earphone primarily comprises a housing 21, an earmuff 22, a speaker unit 10, and a signal input cord 23. The earmuff 22 is fixed to the housing 21 and defines, together with the housing 21, an accommodating space S1 in which the speaker unit 10 is arranged. The signal input cord 23 penetrates into the housing 21 and is electrically connected with the speaker unit 10.

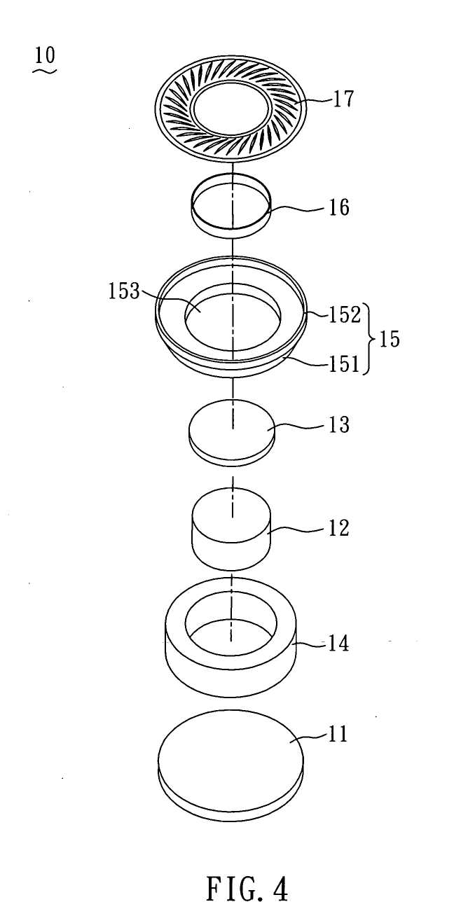

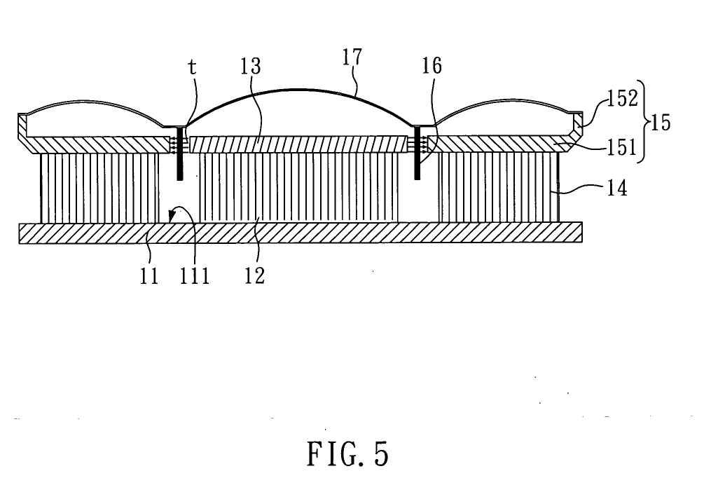

Further referring to FIG. 4, an exploded view illustrating a speaker unit according to the first embodiment of the present invention, and to FIG. 5, a cross-sectional view illustrating the speaker unit, the speaker unit 10 includes a ferrite yoke plate 11, an inner magnet 12, a first pole member 13, an outer magnet 14, a second pole member 15, and a diaphragm 16. The inner magnet 12 is cylindrical, while the outer magnet 14 is annular, and both the inner and the outer magnets 12,14 are disposed and secured, with their bottoms, on a loading surface 111 of the ferrite yoke plate 11 such that the annular outer magnet 14 surrounds, and is spaced apart from, the inner magnet 12.

Further, according to the present embodiment, the first pole member 13 is disk-like, and is fixed on top of the inner magnet 12 such that the first pole member 13 has a diameter greater than that of the inner magnet 12. The second pole member 15 is bowl-like, and includes a bowl-bottom portion 151 and a bowl-edge portion 152 extending obliquely upward from circumference of the bowl-bottom portion 151, where a hole 153 is provided at center of the bowl-bottom portion 151. The second pole member 15 is fixed, with its bowl-bottom portion 151, to top of the outer magnet 14. At least part of the first pole member 13 is arranged in the hole 153, so that the two pole members 13,15 are overlapped in an axial direction. Besides, the outer circumference of the first pole member 13 and the inner circumference of the second pole member 15 are radially spaced apart from each other so as to define an annular gap t.

The diaphragm 16 is stretched above the two pole members 13,15 such that the side of the diaphragm 16 is fixed at the bowl-edge portion 152 of the second pole member 15. An annular voice coil 17 abuts, at one end, on a surface of the diaphragm 16 close to the pole members 13,15; while extends axially, at the other end, into the gap t.

It should be noted that the inner and the outer magnets 12,14 have to be arranged in such a manner that the corresponding pole members 13,15 are induced to opposite polarities. For example, the inner magnet 12 makes the first pole member 13 induced as an N pole; while the outer magnet 14 makes the second pole member 15 induced as an S pole.

As shown in FIG. 5, through the above-mentioned twin-magnet speaker structure, according to the present embodiment, a magnetic line of force is distributed between the first pole member 13 and the second pole member 15, namely, from circumference of the first pole member 13 directing to circumference of the second pole member 15, appeared as a state of significantly concentrated, unlike the conventional art that the magnetic line of force is distributed to the whole vertical portion 812,912 of the ferrite yoke 81,91 resulting in a poor driving efficiency. The present invention, if applied to a thin-desktop speaker or an earphone, will manifest a predominant effect.

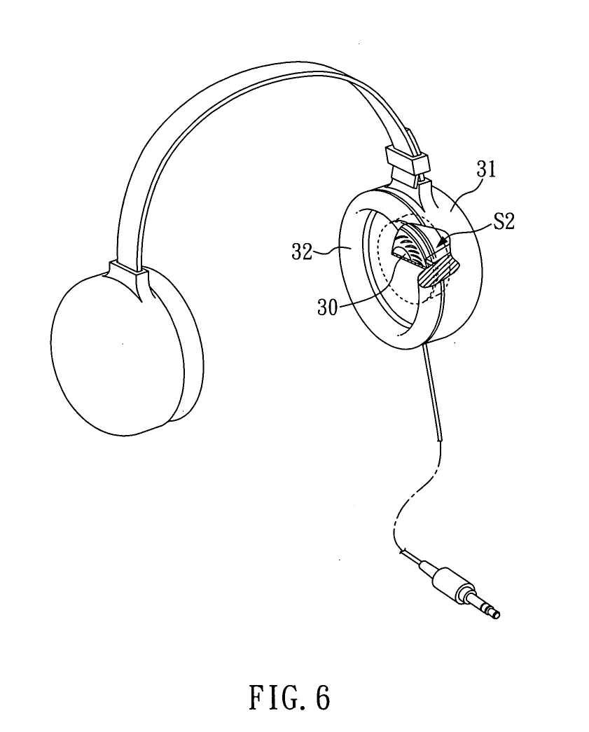

Now referring to FIG. 6, a perspective view illustrating a headphone embodying a speaker according to a second embodiment of the present invention, the headphone includes a housing 31, a speaker unit 30, and an earmuff 32. The speaker unit 30 has a structure similar to that of the first embodiment, and as such, no further redundant description is necessary. The earmuff 32 is made of soft leather. In the present embodiment, the speaker unit 30 is arranged in an accommodating space S2 surrounded and defined by the housing 31 and the earmuff 32.

Although the present invention has been explained in relation to its preferred embodiments, it is to be understood that many other possible modifications and variations can be made without departing from the scope of the invention as hereinafter claimed.

What is claimed is:

1. A speaker, comprising:
a ferrite yoke plate;
an inner magnet, being disposed on the ferrite yoke plate;
a first pole member, being disposed on a top of the inner magnet;
an outer magnet, being disposed on the ferrite yoke plate, and being spaced apart from the inner magnet;
a second pole member, being disposed on a top of the outer magnet, wherein a circumference of the first pole member and a circumference of the second pole member are spaced apart from each other and define a gap;
a diaphragm; and
a voice coil, being connected with the diaphragm, and extending axially into the gap between the two pole members.

2. The speaker as claimed in claim 1, further comprising a housing and an earmuff, wherein the housing and the earmuff define an accommodating space such that the ferrite yoke plate, the inner magnet, the first pole member, the outer magnet, the second pole member, the diaphragm, and the voice coil are received in the accommodating space.

3. The speaker as claimed in claim 1, wherein the speaker relates to an earphone.

4. The speaker as claimed in claim 1, wherein the speaker relates to a headphone.
